(19) United States
(12) Patent Application Publication
(10) Pub. No.: US 2021/0405273 A1
(43) Pub. Date: Dec. 30, 2021

(54) POLARIZING PLATE AND LIQUID CRYSTAL DISPLAY DEVICE INCLUDING SAME

(71) Applicant: Samsung SDI Co., Ltd., Yongin si Gyeonggi-do (KR)

(72) Inventors: Jun Mo KOO, Suwon-si (KR); Jung Hun YOU, Suwon-si (KR); Sang Hum LEE, Suwon-si (KR); Dong Yoon SHIN, Suwon-si (KR)

(21) Appl. No.: 17/295,702

(22) PCT Filed: Dec. 23, 2019
(86) PCT No.: PCT/KR2019/018276

§ 371 Date: May 20, 2021

(30) Foreign Application Priority Data
Dec. 27, 2018 (KR) 10-2018-0171339

(51) Int. Cl. G02B 5/30; G02F 1/1335

(52) U.S. Cl. CPC G02B 5/3083; G02B 5/305; G02F 1/133528

(57) ABSTRACT

The present invention provides a polarizing plate and a liquid crystal display device comprising same, the polarizing plate comprising: a polarizer; and a first retardation layer and a second retardation layer formed on one surface of the polarizer, wherein the first retardation layer has a thickness direction retardation (Rth) of about −75 nm to about −130 nm at a wavelength of about 550 nm, the second retardation layer satisfies Relations 1 and 2, a laminated body of the first retardation layer and the second retardation layer has a thickness direction retardation (Rth) of about −70 nm to about 0 nm at a wavelength of about 550 nm, and the first retardation layer includes a coating layer formed of a composition containing a cellulose ester-based compound.

### TECHNICAL FIELD

The present invention relates to a polarizing plate and a liquid crystal display device including the same.

### BACKGROUND ART

An IPS (In-Plane Switching) liquid crystal display includes a first polarizing plate, an IPS liquid crystal panel, and a second polarizing plate. An absorption axis of the first polarizing plate is orthogonal to an absorption axis of the second polarizing plate. The absorption axis of the first polarizing plate is parallel to an optical axis of the IPS liquid crystal panel. The IPS liquid crystal display can have a low contrast ratio and high light leakage characteristics at right and left inclined angles (opposite angles) due to birefringence characteristics of the liquid crystal panel and viewing angle dependency of the first polarizing plate and the second polarizing plate orthogonal to each other.

The background technique of the present invention is disclosed in Korean Patent Laid-open Publication No. 10-2016-0006817 and the like.

### DISCLOSURE

### Technical Problem

It is one aspect of the present invention to provide a polarizing plate that maximizes a right-left opposite angle compensation function.

It is another aspect of the present invention to provide a polarizing plate that prevents light leakage while improving a side contrast ratio (CR) by reducing brightness in a black mode at right and left opposite angles.

It is a further aspect of the present invention to provide a polarizing plate that has improved contrast ratio at sides (20°, 50°) in the spherical coordinate system (azimuth angle θ, polar angle f).

### Technical Solution

One aspect of the present invention relates to a polarizing plate.

In Embodiment 1, a polarizing plate includes: a polarizer; and first and second retardation layers formed on one surface of the polarizer, wherein the first retardation layer has an out-of-plane retardation Rth of about −130 nm to about −75 nm at a wavelength of about 550 nm, the second retardation layer satisfies Relations 1 and 2, a laminate of the first retardation layer and the second retardation layer has an out-of-plane retardation Rth of about −70 nm to about 0 nm at a wavelength of about 550 nm, and the first retardation layer is formed of a composition including a cellulose ester compound:

about 0.8≤Re(450)/Re(550)≤about 1.05 [Relation 1]

about 0.95≤Re(650)/Re(550)≤about 1.10. [Relation 2]

where

Re(450), Re(550), and Re(650) denote in-plane retardations Re (unit: nm) of the second retardation layer at wavelengths of 450 nm, 550 nm, and 650 nm, respectively.

2. In Embodiment 1, the first retardation layer and the second retardation layer may be sequentially stacked in the stated sequence from the polarizer.

3. In Embodiments 1 and 2, assuming that an absorption axis of the polarizer is about 0°, an angle between a slow axis of the second retardation layer and the absorption angle of the polarizer may range from about −5° to about +5°.

4. In Embodiments 1 to 3, the second retardation layer may have an in-plane retardation Re of about 100 nm to about 150 nm at a wavelength of about 550 nm.

5. In Embodiments 1 to 4, the second retardation layer may have an out-of-plane retardation Rth of about 40 nm to about 120 nm at a wavelength of about 550 nm.

6. In Embodiments 1 to 5, the second retardation layer may be an MD uniaxially stretched film.

7. In Embodiments 1 to 6, the second retardation layer may include a fluorene retardation layer.

8. In Embodiment 7, the fluorene retardation layer may include a compound represented by Formula 1:

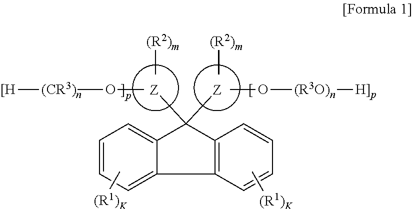

where Z is an aromatic hydrocarbon group; R¹ and R² are each independently a substituent group; R³ is a C₁ to C₁₀ alkylene group; n is an integer of 0 or more; k is an integer of 0 to 4; m is an integer of 0 or more, and p is an integer of 1 or more.

9. In Embodiments 1 to 8, the first retardation layer may have an in-plane retardation Re of about 10 nm or less at a wavelength of about 550 nm.

10. In Embodiments 1 to 9, the first retardation layer may be formed of a composition for the first retardation layer including the cellulose ester compound and an aromatic fused ring-containing additive.

11. In Embodiment 10, the aromatic fused ring-containing additive may be present in an amount of about 0.1 wt % to about 30 wt % in the first retardation layer.

12. In Embodiments 1 to 11, the cellulose ester compound may include at least one selected from among cellulose acetate, cellulose acetate propionate, and cellulose acetate butyrate.

13. In Embodiment 10, the aromatic fused ring-containing additive may include at least one selected from among naphthalene, anthracene, phenanthrene, pyrene, Structure 1, Structure 2, 2-naphthyl benzoate, 2,6-naphthalene dicarboxylic acid diester of Structure 3, and an abietic acid ester of Structure 4:

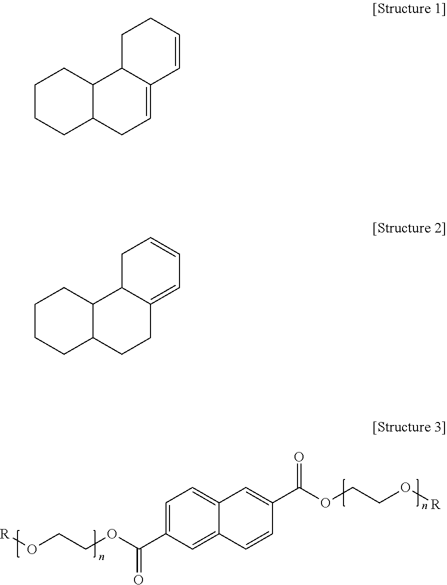

where R is a C₁ to C₂₀ alkyl or a C₆ to C₂₀ aryl, and n is an integer of 0 to 6

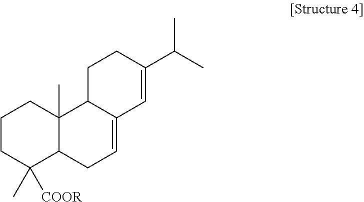

where R is a C₁ to C₂₀ alkyl or a C₆ to C₂₀ aryl.

14. In Embodiments 1 to 13, the first retardation layer may be directly formed on the second retardation layer.

15. In Embodiments 1 to 14, the first retardation layer may have a thickness of about 2 μm to about 10 μm.

16. In Embodiments 1 to 15, the laminate may satisfy Relations 6 and 7:

about 0.9≤Rth(450)/Rth(550)≤about 1.3 [Relation 6]

about 0.8≤Rth(650)/Rth(550)≤about 1.1 [Relation 7]

where

Rth(450), Rth(550), and Rth(650) denote out-of-plane retardations Rth (unit: nm) of the laminate at wavelengths of 450 nm, 550 nm, and 650 nm, respectively.

17. In Embodiments 1 to 16, the laminate may have an in-plane retardation Re of about 100 nm to 150 nm at a wavelength of about 550 nm.

18. In Embodiments 1 to 16, the laminate may have a degree of biaxiality (NZ) of about −0.1 to about 0.5 at a wavelength of about 550 nm.

19. In Embodiments 1 to 17, the polarizing plate may further include a protective film on the other surface of the polarizer.

A liquid crystal display device according to the present invention includes the polarizing plate according to the present invention.

### Advantageous Effects

The present invention provides a polarizing plate that maximizes a right-left opposite angle compensation function.

The present invention provides a polarizing plate that prevents light leakage while improving a side contrast ratio by reducing brightness in a black mode at right and left opposite angles.

The present invention provides a polarizing plate that has improved contrast ratio at sides (20°, 50°) in the spherical coordinate system (azimuth angle θ, polar angle ϕ).

### DESCRIPTION OF DRAWINGS

FIG. 1 is a sectional view of a polarizing plate according to one embodiment of the present invention.

### BEST MODE

Hereinafter, embodiments of the present invention will be described in detail with reference to the accompanying drawings. It should be understood that the present invention may be embodied in different ways and is not limited to the following embodiments. The following embodiments of the present invention will be described in detail with reference to the accompanying drawings to provide thorough understanding of the invention to those skilled in the art. Although lengths, thicknesses or widths of various components may be exaggerated for understanding in the drawings, the present invention is not limited thereto. Like components will be denoted by like reference numerals throughout the drawings.

Herein, spatially relative terms such as “upper” and “lower” are defined with reference to the accompanying drawings. Thus, it will be understood that the term “upper surface” can be used interchangeably with the term “lower surface”, and when an element such as a layer or a film is referred to as being placed “on” another element, it can be directly placed on the other element, or intervening element(s) may be present. On the other hand, when an element is referred to as being placed “directly on” another element, there are no intervening element(s) therebetween.

Herein, “in-plane retardation Re”, “out-of-plane retardation Rth”, and “degree of biaxiality NZ” are represented by Equations A, B and C, respectively:

Re=(nx−ny)×d [Equation A]

Rth=((nx+ny)/2−nz)×d [Equation B]

NZ=(nx−nz)/(nx−ny) [Equation C]

where nx, ny, and nz denote indexes of refraction of a corresponding optical device in the slow axis direction, the fast axis direction and the thickness direction of the optical device at a measurement wavelength, respectively, and d denotes the thickness of the optical device (unit: nm).

In Relations A to C, the “optical device” means a first retardation layer, a second retardation layer or a laminate of the first retardation layer and the second retardation layer. In Equations A to C, the “measurement wavelength” means a wavelength of about 450 nm, about 550 nm or about 650 nm.

As used herein to represent a specific numerical range, the expression “X to Y” means “X≤and ≤Y”.

A polarizing plate according to the present invention is a polarizing plate used in an IPS liquid crystal display.

The polarizing plate according to the present invention includes a polarizer; and first and second retardation layers formed on one surface of the polarizer. All of out-of-plane retardation Rth of the first retardation layer at a wavelength of about 550 nm, wavelength dispersion of the second retardation layer, and out-of-plane retardation Rth of a laminate of the first retardation layer and the second retardation layer at a wavelength of about 550 nm are adjusted. With this structure, the polarizing plate can have an improved right-left opposite angle compensation function. That is, in an IPS liquid crystal display, the polarizing plate can maximize the right-left opposite angle compensation function and can increase brightness in a white mode while reducing brightness in a black mode at right and left opposite angles, thereby preventing light leakage while improving a side contrast ratio (CR). Specifically, the polarizing plate may have a contrast ratio of 350 or more at sides (20°, 50°) in the spherical coordinate system (azimuth angle θ, polar angle ϕ). Further, in the polarizing plate according to the present invention, the first retardation layer is directly formed on the second retardation layer, thereby providing economically advantageous effects while allowing reduction in thickness of the polarizing plate through elimination of an adhesive layer, a bonding layer or adhesive/bonding layer between the first retardation layer and the second retardation layer.

In one embodiment, the laminate of the first retardation layer and the second retardation layer may be stacked on a light incidence surface of the polarizer in the polarizing plate. In this embodiment, the polarizing plate is used as a viewer-side polarizing plate in the IPS liquid crystal display. The second retardation layer, the first retardation layer, and the polarizer are sequentially stacked on the IPS liquid crystal panel in the stated sequence. The viewer-side polarizing plate means a polarizing plate stacked on a light exit surface of the IPS liquid crystal panel.

In another embodiment, the laminate of the first retardation layer and the second retardation layer may be stacked on a light exit surface of the polarizer in the polarizing plate. In this embodiment, the polarizing plate is used as a light source-side polarizing plate in the IPS liquid crystal display. The second retardation layer, the first retardation layer, and the polarizer are sequentially stacked on the IPS liquid crystal panel in the stated sequence. The light source-side polarizing plate means a polarizing plate stacked on a light incidence surface of the IPS liquid crystal panel.

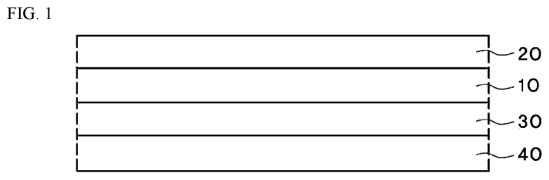

Next, a polarizing plate according to one embodiment of the present invention will be described with reference to FIG. 1.

Referring to FIG. 1, the polarizing plate includes a polarizer 10, a protective film 20 stacked on an upper surface of the polarizer 10, and a first retardation layer 30 and a second retardation layer 40 sequentially stacked on a lower surface of the polarizer 10 in the stated sequence from the polarizer 10.

The lower surface of the polarizer corresponds to the light incidence surface of the polarizer and the upper surface of the polarizer corresponds to the light exit surface of the polarizer. That is, the first retardation layer and the second retardation layer are sequentially stacked on the light incidence surface of the polarizer in the stated sequence from the polarizer. Alternatively, the first retardation layer and the second retardation layer may be sequentially stacked on the light exit surface of the polarizer.

The polarizing plate according to the embodiment satisfies all conditions for (i) out-of-plane retardation Rth of the first retardation layer at a wavelength of about 550 nm, (ii) wavelength dispersion of the second retardation layer, and (iii) out-of-plane retardation Rth of the laminate of the first retardation layer and the second retardation layer at a wavelength of about 550 nm. As a result, the polarizing plate can maximize the right-left opposite angle compensation function and can increase brightness in a white mode while reducing brightness in a black mode at right and left opposite angles, thereby preventing light leakage while improving the side contrast ratio (CR). If the polarizing plate fails to satisfy any one of the conditions (i), (ii) and (iii), the polarizing plate cannot achieve advantageous effects of the present invention.

When the polarizing plate fails to satisfy the condition (iii) while satisfying the conditions (i) and (ii), the polarizing plate cannot achieve right-left opposite angle compensation and reduction in brightness in the black mode at right and left opposite angles and can suffer change in visibility depending upon angle of incidence.

When the polarizing plate fails to satisfy the condition (i) while satisfying the conditions (ii) and (iii), the polarizing plate cannot achieve right-left opposite angle compensation and reduction in brightness at right and left opposite angles. When the first retardation layer has an out-of-plane retardation Rth of less than about −130 nm, the coating thickness must be increased, thereby making it difficult to perform direct coating using the second retardation layer as a matrix. If the first retardation layer has an out-of-plane retardation Rth of greater than about −75 nm, there is a problem of difficulty in increasing the contrast ratio due to insufficient compensation of the out-of-plane retardation Rth of the second retardation layer.

When the polarizing plate fails to satisfy the condition (ii) while satisfying the conditions (i) and (iii), the polarizing plate cannot achieve right-left opposite angle compensation and reduction in brightness in the black mode at right and left opposite angles and can suffer change in visibility depending upon angle of incidence.

When the laminating sequence of the first retardation layer and the second retardation layer from the polarizer is changed in the polarizing plate, that is, when the polarizing plate has the laminating sequence of the polarizer, the second retardation layer and the first retardation layer, the polarizing plate suffers from significant deterioration in effects of right-left opposite angle compensation and preventing light leakage at right and left opposite angles.

The polarizing plate according to the present invention is configured to allow light emitted from the liquid crystal panel to reach the polarizer after passing through the second retardation layer and the first retardation layer. In the polarizing plate, wavelength dispersion of the second retardation layer is adjusted.

The second retardation layer 40 satisfies Relations 1 and 2. With the second retardation layer satisfying Relations 1 and 2 at the same time, the polarizing plate can have good effects in right-left opposite angle compensation and prevention of light leakage at right and left opposite angles when used in a liquid crystal display.

about 0.8≤Re(450)/Re(550)≤about 1.05 [Relation 1]

about 0.95≤Re(650)/Re(550)≤about 1.10. [Relation 2]

In Relations 1 and 2,

Re(450), Re(550), and Re(650) denote in-plane retardations Re (unit: nm) of the second retardation layer at wavelengths of 450 nm, 550 nm, and 650 nm, respectively.

Light emitted from the liquid crystal panel passes through the second retardation layer satisfying Relations 1 and 2 to have wavelength dispersion, whereby difference in change of phase difference of polarized light depending upon the wavelength of light having passed through the second retardation layer can be reduced as much as possible, thereby providing as constant a color as possible according to azimuth angle.

For example, Re(450)/Re(550) may be in the range of about 0.85 to about 0.95 or about 0.95 to about 1.05.

For example, Re(650)/Re(550) may be in the range of about 0.95 to about 1.00 or about 1.01 to about 1.10.

For example, Re(450)/Re(550) may be in the range of about 0.85 to about 0.95 and Re(650)/Re(550) may be in the range of about 1.01 to about 1.10.

For example, Re(450)/Re(550) may be in the range of about 0.95 to about 1.05, preferably greater than about 1.00 to about 1.05, and Re(650)/Re(550) may be in the range of about 0.95 to about 1.00, preferably about 0.95 to less than about 1.00.

In Relations 1 and 2, the second retardation layer 40 may have an in-plane retardation Re(450) of about 75 nm to about 140 nm, preferably about 95 nm to about 120 nm, about 100 nm to about 120 nm, about 100 nm to about 140 nm, or about 110 nm to about 140 nm, an in-plane retardation Re(550) of about 100 nm to about 150 nm, preferably about 110 nm to about 140 nm, or about 110 nm to about 130 nm, and an in-plane retardation Re(650) of about 105 nm to about 150 nm, preferably about 105 nm to about 140 nm, or about 110 nm to about 140 nm. Within this range, the polarizing plate can achieve wavelength dispersion of the second retardation layer while securing reduction in lateral visibility difference.

The second retardation layer 40 may have an out-of-plane retardation Rth of about 40 nm to about 120 nm, preferably about 55 nm to about 100 nm, at a wavelength of about 550 nm. Within this range, the polarizing plate can secure reduction in lateral visibility difference.

The second retardation layer 40 may have a degree of biaxiality (NZ) of about 0.9 to about 1.5, preferably about 1 to about 1.3, at a wavelength of about 550 nm. Within this range, the polarizing plate can secure reduction in lateral visibility difference.

In one embodiment, the second retardation layer 40 is a fluorene retardation layer and may be formed of a composition including at least one selected from among a fluorene resin, a fluorene oligomer, and a fluorene monomer.

In the second retardation layer, the fluorene retardation layer increases the glass transition temperature Tg of the second retardation layer to improve durability of the second retardation layer and the polarizing plate and can easily satisfy Relation 1 and Relation 2 upon stretching. In addition, the fluorene retardation layer has low moisture permeability, thereby improving reliability of the second retardation layer and the polarizing plate.

The second retardation layer 40 has a glass transition temperature of about 120° C. or more, preferably about 120° C. to about 150° C., more preferably about 130° C. to about 150° C. Within this range, it is possible to improve reliability of the second retardation layer and the polarizing plate. Herein, “glass transition temperature” may be measured by a typical method known in the art.

The second retardation layer is formed of a composition for the second retardation layer including a fluorene compound and a non-fluorene compound. The second retardation layer can satisfy Relations 1 and 2 at the same time by adjusting the content of the fluorene compound or an additive in the composition for the second retardation layer.

The fluorene compound is a non-epoxy compound having a 9,9-bisaryl fluorene backbone and may include a compound represented by Formula 1:

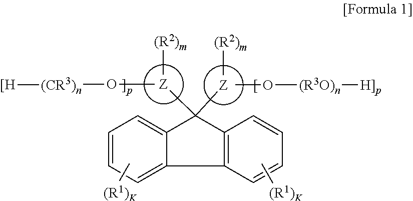

where

Z is an aromatic hydrocarbon group;

R¹ and R² are each independently a substituent group;

R³ is a C₁ to C₁₀ alkylene group;

n is an integer of 0 or more;

k is an integer of 0 to 4; m is an integer of 0 or more, and p is an integer of 1 or more.

In Formula 1, the aromatic hydrocarbon group represented by Z is a C₆ to C₂₀ mono- or fused aromatic hydrocarbon group, for example, a benzene group, a naphthalene group, a non-phenyl group, an anthracene group, a phenanthrene group, a terphenyl group, or a non-naphthyl group, without being limited thereto.

In Formula 1, a substituent represented by R¹ may include a cyano group, a halogen atom, a C₁ to C₁₀ alkyl group, or a C₆ to C₁₀ aryl or acyl group. In Formula 1, a substituent represented by R² may include a C₁ to C₁₀ alkyl group, a C₅ to C₁₀ cycloalkyl group, a C₆ to C₁₀ aryl group, a C₇ to C₁₀ arylalkyl group, a C₁ to C₁₀ alkoxy group, a C₅ to C₁₀ cycloalkoxy group, a C₆ to C₁₀ aryloxy group, a C₇ to C₁₀ aryl alkyloxy group, a C₁ to C₁₀ alkylthio group, a C₁ to C₆ acyl group, a C₁ to C₅ alkoxy carbonyl group, a halogen atom, a nitro group, a cyano group, an amino group, and the like.

In Formula 1, n is an integer of 0 or more, for example, an integer of 0 to 20, an integer of 0 to 15, an integer of 0 to 10, or an integer of 0 to 4. In Formula 1, m is an integer of 0 or more, for example, an integer of 0 to 8, an integer of 0 to 4, or an integer of 0 to 2. In Formula 1, p is an integer of 1 or more, for example, an integer of 1 to 6, an integer of 1 to 4, an integer of 1 to 3, or an integer of 1 to 2.

Specifically, the fluorene compound may include at least one selected from among 9,9-bis(hydroxyphenyl)fluorene, 9,9-bis(alkyl-hydroxyphenyl)fluorene, 9,9-bis(aryl-hydroxyphenyl)fluorene, 9,9-bis(di or trihydroxyphenyl)fluorene, 9,9-bis(hydroxynaphthyl)fluorene, 9,9-bis(hydroxyalkoxyphenyl)fluorene, 9,9-bis(alkyl-hydroxyalkoxyphenyl)fluorene, 9,9-bis(aryl-hydroxyalkoxyphenyl)fluorene, 9,9-bis(hydroxyalkoxynaphthyl)fluorene, 9,9-bis[4-(2-hydroxyethyoxy)phenyl]fluorene(9,9-bis[4-(2-hydroxyethoxy)phenyl]fluorene), 9,9-bis(4-hydroxyphenyl)fluorene(9,9-bis(4-hydroxyphenyl)fluorene), and 9,9-bis(4-hydroxy-3-methylphenyl)fluorene(9,9-bis(4-hydroxy-3-methylphenyl)fluorene), without being limited thereto.

The fluorene compound may be present in an amount of about 10 wt % to about 90 wt %, preferably about 30 wt % to about 60 wt %, in the second retardation layer. Within this range, the second retardation layer can satisfy Relations 1 and 2 while improving thermal stability.

The non-fluorene compound serves to form a matrix of the second retardation layer and includes at least one selected from among a thermoplastic resin, a heat curable resin, and a photocurable resin. The non-fluorene compound is free from a fluorene group.

The thermoplastic resin may include at least one selected from among an olefin resin, a halogen-containing vinyl resin, a vinyl resin, an acryl resin, a styrene resin, a polycarbonate resin, a polythiocarbonate resin, a polyester resin, a polyacetal resin, a polyamide resin, a polyphenylene ether resin, a polysulfone resin, a polyphenylene sulfide resin, a polyimide resin, a polyetherketone resin, a cellulose derivative, an elastomer, and a cyclic olefin polymer (COP). The heat curable resin and the photocurable resin may include at least one selected from among an acryl resin, a phenol resin, an amino resin, a furan resin, an unsaturated polyester resin, a heat curable urethane resin, a silicone resin, a heat curable polyimide resin, and a vinyl ether resin.

Preferably, the non-fluorene compound includes at least one selected from among a polycarbonate resin, a polyester resin, and a cyclic olefin polymer.

The non-fluorene compound may be present in an amount of about 10 wt % to about 90 wt %, preferably about 40 wt % to about 70 wt %, in the second retardation layer. Within this range, the composition for the second retardation layer can suppress breakage and embrittlement of the second retardation layer.

The second retardation layer 40 may be formed from the composition for the second retardation layer by a typical film formation method, such as solvent casting, melt extrusion, calendering, and the like. The second retardation layer may be formed by uniaxial stretching, biaxial stretching or oblique stretching of a non-stretched film. Uniaxial stretching of the non-stretched film may be performed by stretching the non-stretched film in the MD (machine direction) or in the TD (transverse direction) to an elongation of 2 to 5 times an initial length thereof, preferably 2 to 3 times. Biaxial stretching of the non-stretched film may be performed by stretching the non-stretched film in the MD and the TD to an MD elongation of 2 to 4 times, preferably 2 to 3 times, and a TD elongation of 2 to 6 times, preferably 3 to 5 times.

In another embodiment, the second retardation layer 40 may include a film formed of at least one selected from among a cyclic polyolefin resin including a cyclic olefin polymer (COP) and the like, a polycarbonate resin, a polyester resin including polyethylene terephthalate (PET) and the like, a polyethersulfone resin, a polysulfone resin, a polyamide resin, a polyimide resin, a non-cyclic polyolefin resin, a poly(meth)acrylate resin including a poly(methyl methacrylate) resin and the like, a polyvinyl alcohol resin, a polyvinyl chloride resin, and a polyvinylidene chloride resin, without being limited thereto. Preferably, the second retardation layer 40 includes a film formed of a cyclic polyolefin resin including a cyclic olefin polymer (COP) and the like.

The second retardation layer 40 is formed in a film shape and may have a thickness of about 15 μm to about 60 preferably about 20 μm to about 50 Within this range, the second retardation layer can prevent breakage and can reduce shrinkage in the longitudinal direction thereof upon durability evaluation.

Assuming that an absorption axis of the polarizer is about 0°, an angle between a slow axis of the second retardation layer 40 and the absorption angle of the polarizer 10 may range from about −5° to about +5°, preferably about 0°. Within this range, the polarizing plate can secure improvement in brightness of a display device. As used herein to represent an angle, “+” means a clockwise direction with reference to a reference point and “−” means a counterclockwise direction with reference to the reference point.

In this embodiment, the polarizing plate includes the first retardation layer between the polarizer and the second retardation layer, in which the first retardation layer secures the above out-of-plane retardation Rth at a wavelength of about 550 nm and the laminate of the first retardation layer and the second retardation layer has the above out-of-plane retardation Rth at a wavelength of about 550 nm. With this structure, the polarizing plate can secure the right-left opposite angle compensation function and can prevent light leakage by reducing brightness at right and left opposite angles when used in a liquid crystal display.

The first retardation layer 30 has a relation of refractive index: nz>nx≈ny.

The first retardation layer 30 may have an out-of-plane retardation Rth of about −130 nm to about −75 nm at a wavelength of about 550 nm. Within this range, the polarizing plate can secure good effects in right-left opposite angle compensation and prevention of light leakage at right and left opposite angles. Preferably, the first retardation layer has an out-of-plane retardation Rth of about −130 nm to about −85 nm, more preferably about −120 nm to about −90 nm, most preferably about −110 nm, at a wavelength of about 550 nm.

The first retardation layer 30 may satisfy Relations 3 and 4. Within this range, the polarizing plate can reduce visibility difference between right and left sides in a black mode.

about 1≤Rth(450)/Rth(550)≤about 1.15 [Relation 3]

about 0.9≤Rth(650)/Rth(550)≤about 1 [Relation 4]

where

Rth(450), Rth(550), and Rth(650) denote out-of-plane retardations Rth (unit: nm) of the first retardation layer at wavelengths of 450 nm, 550 nm, and 650 nm, respectively.

The first retardation layer 30 may satisfy Relation 5.

Rth(450)≤Rth(550)≤Rth(650) [Relation 5]

where

Rth(450), Rth(550), and Rth(650) denote out-of-plane retardations Rth (unit: nm) of the first retardation layer at wavelengths of 450 nm, 550 nm, and 650 nm, respectively.

The first retardation layer 30 may have an out-of-plane retardation Rth of about −145 nm to about −85 nm, preferably about −130 nm to about −90 nm, more preferably about −120 nm, at a wavelength of about 450 nm, and an out-of-plane retardation Rth of about −125 nm to about −80 nm, preferably about −110 nm to about −70 nm, more preferably about −105 nm, at a wavelength of about 650 nm. Within this range, the polarizing plate can reduce visibility difference between right and left sides while improving the side contrast ratio.

The first retardation layer 30 may have an in-plane retardation Re of about 10 nm or less, preferably about 5 nm or less, more preferably about 0 nm to about 2 nm, at a wavelength of about 550 nm. Within this range, the polarizing plate can improve the side contrast ratio.

The first retardation layer 30 may have a thickness of about 15 μm or less, preferably about 2 μm to about 10 μm (for example, 2, 4, 6, 8 or 10 μm). Within this range, the first retardation layer 30 can be used in the polarizing plate and can reduce the thickness of the polarizing plate.

Based on the confirmation that, when the first retardation layer is formed of a composition including a cellulose ester compound described below and an aromatic fused ring-containing compound, the first retardation layer can achieve the above out-of-plane retardation Rth, and the laminate of the second retardation layer and the first retardation layer can easily reach the above out-of-plane retardation Rth, and durability of the polarizing plate can be improved through application of the first retardation layer having a high glass transition temperature, the inventors of the present invention completed the present invention. In particular, the first retardation layer is formed by coating the composition for the first retardation layer on the second retardation layer, followed by curing the composition, thereby providing economically advantageous effects while allowing reduction in thickness of the polarizing plate through elimination of an adhesive layer, a bonding layer or an adhesive/bonding layer between the first retardation layer and the second retardation layer.

In one embodiment, the first retardation layer 30 may have a glass transition temperature of about 140° C. or more, for example, about 140° C. to about 200° C. Within this range, the polarizing plate can have improved durability.

The first retardation layer 30 is a non-crystal layer formed of the composition for the first retardation layer and thus has high durability. Since liquid crystals are brittle, the liquid crystals have low durability and generally require an alignment layer for alignment of the liquid crystals.

The first retardation layer 30 may be a retardation layer including a cellulose ester compound.

In one embodiment, the first retardation layer may be formed of a composition including the cellulose ester compound.

In another embodiment, the first retardation layer may be formed of a composition including the cellulose ester compound and an aromatic fused ring-containing compound.

The cellulose ester compound may include at least one selected from among a cellulose ester resin, a cellulose ester oligomer, and a cellulose ester monomer.

The cellulose ester compound refers to a condensation product obtained through reaction between a hydroxyl group on a cellulose ester and a carboxylic acid group of carboxylic acid. The cellulose ester compound may be regioselectively or randomly substituted. Regioselectivity may be measured by determining a relative degree of substitution at the positions of C₆, C₃ and C₂ on the cellulose ester by carbon 13 NMR. The cellulose ester compound may be prepared by a typical method through contact between a cellulose solution and at least one C₁ to C₂₀ acylation agent for a sufficient contact time to provide a cellulose ester having a desired degree of substitution and a desired degree of polymerization. Preferably, the acylation agent includes at least one linear or branched C₁ to C₂₀ alkyl or aryl carboxylic anhydride, carboxylic acid halide, diketone, or acetoacetic ester. Examples of the carboxylic anhydride may include acetic anhydride, propionic anhydride, butyric anhydride, isobutyric anhydride, valeric anhydride, hexanoic anhydride, 2-ethylhexanoic anhydride, nonanoic anhydride, lauric anhydride, palmitic anhydride, stearic anhydride, benzoic anhydride, substituted benzoic anhydride, phthalic anhydride, and isophthalic anhydride. Examples of the carboxylic acid halide may include acetyl, propionyl, butyryl, hexanoyl, 2-ethylhexanoyl, lauroyl, palmitoyl, benzoyl, substituted benzoyl, and stearoyl chlorides. Examples of the acetoacetic ester may include methyl acetoacetate, ethyl acetoacetate, propyl acetoacetate, butyl acetoacetate, and tertiary butyl acetoacetate. Most preferably, the acylation agent may include linear or branched C₂ to C₉ alkyl carboxylic acid anhydrides, such as acetic anhydride, propionic anhydride, butyric anhydride, 2-ethylhexanoic anhydride, nonanoic anhydride, and stearic anhydride.

Preferably, the cellulose ester compound includes, for example, cellulose acetate (CA), cellulose acetate propionate (CAP), and cellulose acetate butyrate (CAB), without being limited thereto.

In one embodiment, the cellulose ester compound may include at least two different acyl group substituents. At least one of the acyl groups may include an aromatic substituent and, in the cellulose ester compound, a relative degree of substitution (RDS) may be set in the order of C₆>C₂>C₃. C₆ means a degree of substitution at the position of the number 6 carbon in the cellulose ester, C₂ means a degree of substitution at the number 2 carbon in the cellulose ester, and C₃ means a degree of substitution at the number 3 carbon in the cellulose ester. The aromatic compound may include benzoate or substituted benzoate.

In another embodiment, the cellulose ester compound may include a regioselectively substituted cellulose ester compound having (a) and (b):

(a) a plurality of chromophore-acyl substituents;

(b) a plurality of pivaloyl substituents.

The cellulose ester compound may have a degree of hydroxyl group substitution of about 0.1 to about 1.2 and a degree of chromophore-acyl substitution of about 0.4 to about 1.6; a difference between a total sum of the degree of chromophore-acyl substitution at the number 2 carbon in the cellulose ester compound and the degree of chromophore-acyl substitution at the number 3 carbon in the cellulose ester compound and the degree of chromophore-acyl substitution at the number 6 carbon in the cellulose ester compound may range from about 0.1 to about 1.6; and the chromophore-acyl may be selected from among (i), (ii), (iii), and (iv):

(i) (C₆-C₂₀)aryl-acyl, where aryl is unsubstituted or substituted with 1 to 5 R¹s,

(ii) heteroaryl, where heteroaryl is a five to ten-membered ring having 1 to 4 hetero atoms selected from among N, O and S, and is unsubstituted or substituted with 1 to 5 R¹s;

(iii)

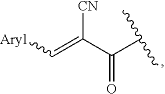

where aryl is C₁-C₆ aryl and is unsubstituted or substituted with 1 to 5 R¹s,

(iv)

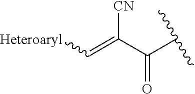

where heteroaryl is a five to ten-membered ring having 1 to 4 hetero atoms selected from among N, O and S, and is unsubstituted or substituted with 1 to 5 les,

R¹s being each independently nitro, cyano, (C₁-C₆)alkyl, halo(C₁-C₆)alkyl, (C₆-C₂₀)aryl-CO₂—, (C₆-C₂₀)aryl, (C₁-C₆)alkoxy, halo(C₁-C₆)alkoxy, halo, five to ten-membered heteroaryl having 1 to 4 hetero atoms selected from among N, O and S, or

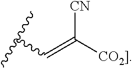

In one embodiment, the chromophore-acyl may be unsubstituted or substituted benzoyl or unsubstituted or substituted naphthyl.

In one embodiment, the chromophore-acyl may be selected from the group consisting of:

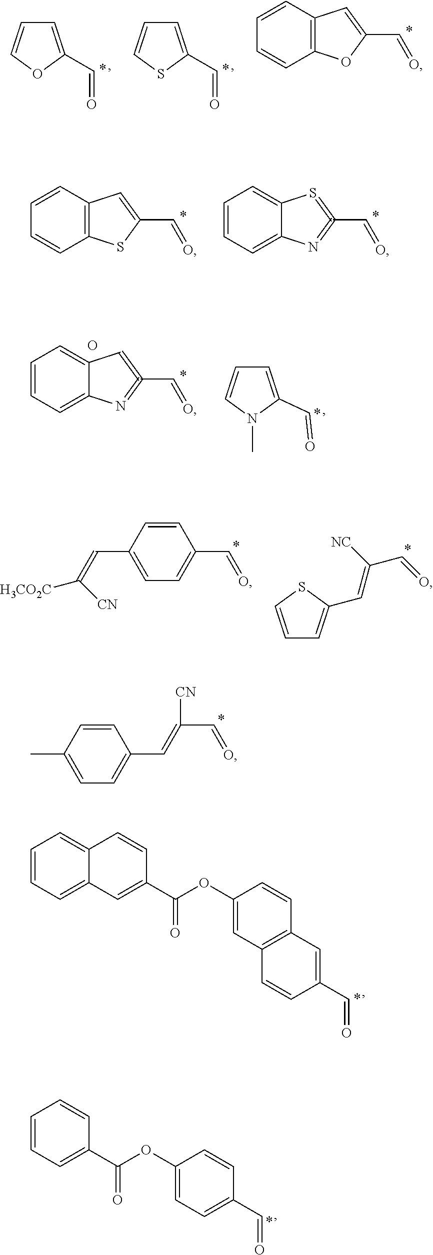

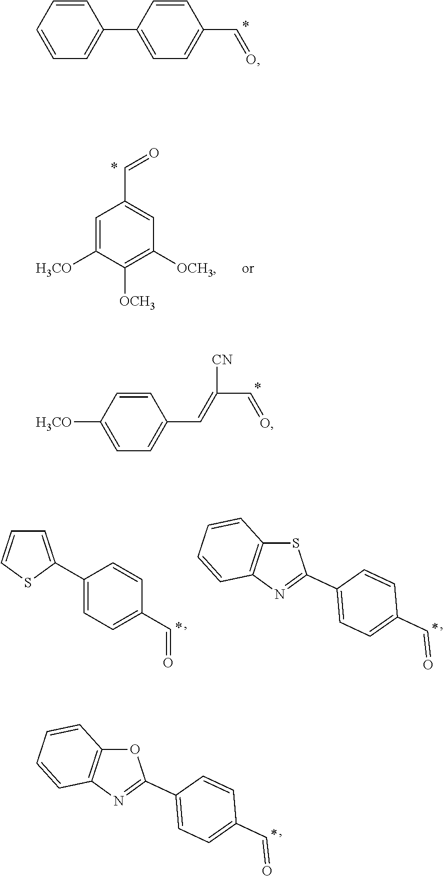 [SMILES: O=Cc1ccc(-c2ccccc2)cc1 ; COc1cc(C=O)cc(OC)c1OC ; COc1ccc(/C=C(\C#N)C=O)cc1 ; O=Cc1ccc(-c2cccs2)cc1 ; O=Cc1ccc(-c2nc3ccccc3s2)cc1 ; O=Cc1ccc(-c2nc3ccccc3o2)cc1]

where * indicates a linking site of the chromophore-acyl substituent to oxygen of the cellulose ester.

The first retardation layer may further include an aromatic fused ring-containing additive.

The aromatic fused ring-containing additive serves to adjust an out-of-plane retardation (Rth) exhibition rate and wavelength dispersion of the first retardation layer. The aromatic fused ring-containing additive may include naphthalene, anthracene, phenanthrene, pyrene, a compound represented by Structure 1, or a compound represented by Structure 2. The aromatic fused ring containing additive may include 2-naphthyl benzoate, 2,6-naphthalene dicarboxylic acid diester represented by Structure 3, naphthalene, and an abietic acid ester represented by Structure 4, without being limited thereto:

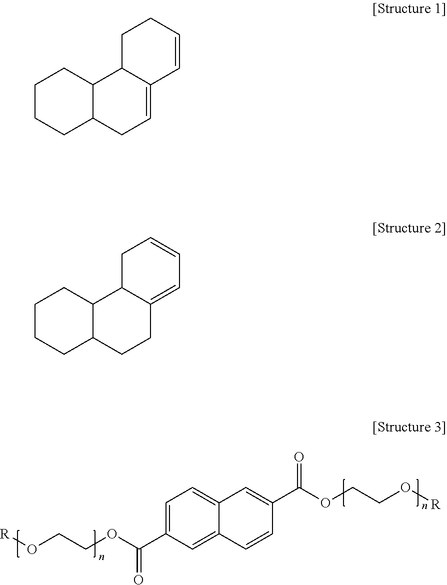

where R is a C₁ to C₂₀ alkyl or a C₆ to C₂₀ aryl, and n is an integer of 0 to 6.

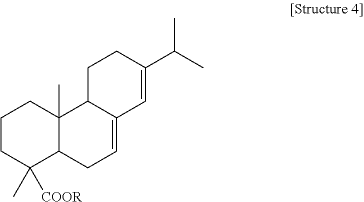

where R is a C₁ to C₂₀ alkyl or a C₆ to C₂₀ aryl.

Preferably, the aromatic fused ring-containing additive includes an additive having an aromatic ring, for example, at least one selected from among naphthalene, anthracene, phenanthrene, pyrene, 2-naphthyl benzoate, and 2,6-naphthalene dicarboxylic acid diester represented by Structure 3.

The aromatic fused ring-containing additive may be present in an amount of 0.1 wt % to 30 wt %, preferably 10 wt % to 30 wt %, in the first retardation layer. Within this range, the additive can improve thermal stability of the composition and retardation of the polarizing plate per thickness, and can adjust wavelength dispersion.

The first retardation layer 30 may further include a plasticizer, a stabilizer, a UV absorbent, an anti-blocking agent, a slipping agent, a lubricant, pigments, dyes, and a retardation enhancer, without being limited thereto.

The first retardation layer 30 is a non-stretched layer formed of a polymer and may be formed by directly coating the composition for the first retardation layer on one surface of the second retardation layer, followed by curing. Coating may be performed by a typical method known in the art, for example, Meyer-bar coating, die coating, and the like.

Laminate of Second Retardation Layer and First Retardation Layer

The laminate of the second retardation layer 40 and the first retardation layer 30 may have an out-of-plane retardation Rth of about −70 nm to about 0 nm at a wavelength of about 550 nm. Within this range, the polarizing plate can secure effects in opposite angle compensation and prevention of light leakage by reducing brightness in a dark mode at opposite angles. Preferably, the laminate has an out-of-plane retardation Rth of about −65 nm to about 0 nm, more preferably about −65 nm to about −15 nm, about −40 nm to about −15 nm, at a wavelength of about 550 nm.

The laminate having the above out-of-plane retardation Rth at a wavelength of about 550 nm may be realized by coating the composition for the first retardation layer on the second retardation layer 40 while adjusting the out-of-plane retardation Rth of the first retardation layer at a wavelength of about 550 nm.

The laminate may satisfy Relation 6 and Relation 7. As a result, the polarizing plate can improve contrast ratio at right and left sides.

about 0.9≤Rth(450)/Rth(550)≤about 1.3 [Relation 6]

about 0.8≤Rth(650)/Rth(550)≤about 1.1 [Relation 7]

where

Rth(450), Rth(550), and Rth(650) denote out-of-plane retardations Rth (unit: nm) of the laminate at wavelengths of 450 nm, 550 nm, and 650 nm, respectively.

The laminate of the second retardation layer 40 and the first retardation layer 30 may have an in-plane retardation Re of about 100 nm to about 150 nm, preferably about 110 nm to about 135 nm, about 110 nm to about 130 nm, at a wavelength of about 550 nm. Within this range, the polarizing plate can improve contrast ratio at right and left sides.

The laminate of the second retardation layer 40 and the first retardation layer 30 may have a degree of biaxiality (NZ) of about −0.1 to about 0.5, preferably about −0.05 to about 0.5, about 0.05 to about 0.5, about 0.1 to about 0.4, at a wavelength of about 550 nm. Within this range, the polarizing plate can reduce light leakage at lateral sides.

Polarizer

The polarizer 10 may include a polyvinyl alcohol-based polarizer manufactured by uniaxially stretching a polyvinyl alcohol film or a polyene-based polarizer manufactured by dehydrating a polyvinyl alcohol film. The polarizer 10 may have a thickness of about 5 μm to about 40 Within this range, the polarizer can be used in a display device.

Protective Film

The protective film 20 may include at least one optically transparent protective film.

The protective film may be a film formed of, for example, at least one resin selected from among cellulose resins including triacetylcellulose (TAC) and the like, cyclic polyolefin resins including a cyclic olefin polymer (COP) and the like, polycarbonate resins, polyester resins including polyethylene terephthalate (PET), polyether sulfone resins, polysulfone resins, polyamide resins, polyimide resins, non-cyclic polyolefin resins, poly(meth)acrylate resins including a poly(methyl methacrylate) resin and the like, polyvinyl alcohol resins, polyvinyl chloride resins, and polyvinylidene chloride resins, without being limited thereto.

A functional coating layer may be further formed on the other surface of the protective film. The functional coating layer may include at least one selected from among a primer layer, a hard coating layer, an anti-fingerprint layer, an anti-reflection layer, an anti-glare layer, a low reflectivity layer, and a super-low reflectivity layer.

The protective film may be stacked on the polarizer via an adhesive layer, a bonding layer or an adhesive/bonding layer. The adhesive layer, the bonding layer or the adhesive/bonding layer may be formed of a typical pressure-sensitive adhesive, without being limited thereto.

Although not shown in FIG. 1, a bonding layer may be formed between the polarizer and the first retardation layer. The bonding layer may be formed of a water-based bonding agent, a photo-curable bonding agent, or the like.

Next, a liquid crystal display device according to the present invention will be described.

The liquid crystal display device according to the present invention may include at least one polarizing plate according to the present invention. The liquid crystal display device may include an IPS liquid crystal type display. The polarizing plate according to the present invention may be used as a viewer-side polarizing plate or a light source-side polarizing plate in the liquid crystal display device.

In one embodiment, the liquid crystal display device includes a light source-side polarizing plate, a liquid crystal panel, and a viewer-side polarizing plate, in which the viewer-side polarizing plate includes the second retardation layer, the first retardation layer, and the polarizer sequentially stacked in the stated sequence from the liquid crystal panel.

In another embodiment, the liquid crystal display device includes a light source-side polarizing plate, a liquid crystal panel, and a viewer-side polarizing plate, in which the light source-side polarizing plate includes the second retardation layer, the first retardation layer, and the polarizer sequentially stacked in the stated sequence from the liquid crystal panel.

Next, the present invention will be described in more detail with reference to examples. However, it should be noted that these examples are provided for illustration only and should not be construed in any way as limiting the invention.

### Example 1

A polyvinyl alcohol film was stretched to 3 times an initial length thereof in an iodine solution at 60° C. to allow adsorption of iodine thereto, followed by stretching the polyvinyl alcohol film to 2.5 times the length of the stretched film in an aqueous solution of boric acid at 60° C., thereby preparing a 12 μm thick polarizer.

As a protective film, a triacetylcellulose (TAC) film (KC2UAW, Konica Minolta Opto Inc.) was attached to a light exit surface of the polarizer.

50 parts by weight of a polycarbonate polyester resin, 50 parts by weight of a fluorene compound (9,9-bisarylfluorene compound, TS9HT, Oosaka Gas Chemical Inc.), and methyl ethyl ketone were mixed to prepare a second retardation layer composition. The second retardation layer composition was melt-kneaded to prepare a resin composition in the form of pellets. The resin composition was subjected to melt pressing through a press machine, thereby preparing a non-stretched film. The non-stretched film was stretched by an MD uniaxial stretching method, thereby manufacturing a second retardation layer (thickness: 50 μm).

A first retardation layer composition was prepared by mixing 50 parts by weight of cellulose acetate propionate (Eastman Inc.), 15 parts by weight of a fused ring-containing additive (2-naphthyl benzoate), and methyl ethyl ketone.

A laminate of the first retardation layer and the second retardation layer was formed by coating the first retardation layer composition to a predetermined thickness on the second retardation layer, followed by curing.

The laminate of the first retardation layer and the second retardation layer was attached to a light incidence surface of the polarizer, thereby providing a polarizing plate in which the triacetylcellulose film, the polarizer, the first retardation layer (thickness: 5.5 μm), and the second retardation layer are sequentially stacked in the stated sequence. In the polarizing plate, an angle between an absorption angle of the polarizer and a slow axis of the second retardation layer was 0°.

Details of the first retardation layer, the second retardation layer, and the laminate of the first retardation layer and the second retardation layer are shown in Table 1.

### Example 2

A polarizing plate was manufactured in the same manner as in Example 1 except that the first retardation layer was formed through adjustment in coating thickness as listed in Table

### Example 3

A polarizing plate was manufactured in the same manner as in Example 1 except that the first retardation layer was formed through adjustment in coating thickness and the second retardation layer was formed through adjustment in MD elongation as listed in Table 1.

### Example 4

A polarizing plate was manufactured in the same manner as in Example 1 except that the first retardation layer was formed through adjustment in coating thickness and the second retardation layer was formed using a cyclic olefin polymer film (Zeon, Z135 Film) having a retardation value as listed in Table 1.

### Example 5

A polarizing plate was manufactured in the same manner as in Example 1 except that the first retardation layer was formed through adjustment in coating thickness and the second retardation layer was formed using a cyclic olefin polymer film (Zeon, Z110 Film) having a retardation value as listed in Table 1.

### Comparative Examples 1 to 5

Each of polarizing plates was manufactured in the same manner as in Example 1 except that the second retardation layer was formed through adjustment in the content of a fluorene compound and the first retardation layer was formed through adjustment in coating thickness.

### Comparative Example 6

Although it was attempted to manufacture a polarizing plate using an acryl film instead of the first retardation layer in the same manner as in Example 1, the acryl film failed to have retardation of the first retardation layer according to the present invention due to low chemical resistance of the acryl film, making it difficult to perform property evaluation.

Each of the polarizing plates manufactured in Examples and Comparative Examples was evaluated as to the following properties shown in Tables 1 and 2.

(1) Retardation: In the polarizing plates manufactured in Examples and Comparative Examples, retardation of each of the first retardation layer, the second retardation layer, and the laminate of the first retardation layer and the second retardation layer was measured using an AxoScan polarimeter.

(2) Contrast ratio: Each of the polarizing plates manufactured in Examples and Comparative Examples was attached to a viewer side of an IPS liquid crystal panel and a general polarizing plate (in which a triacetylcellulose film, a polarizer and a triacetylcellulose film were stacked in the stated sequence) was attached to a light source side thereof to manufacture a module for measurement of contrast ratio. Here, in the polarizing plate attached to the viewer side, the second retardation layer, the first retardation layer, the polarizer, and the protective film were stacked in the stated sequence from the IPS liquid crystal panel.

Contrast ratio was measured using an EZ-contrast 3D measurement instrument (Eldim Inc., French) by measuring brightness in a black mode and in a white mode, followed by calculating [brightness in white mode/brightness in black mode]. The contrast ratio was evaluated at sides (20°, 50°) in the spherical coordinate system.

TABLE 1

| | | Example | | | | |
|---|---|---|---|---|---|---|
| | | 1 | 2 | 3 | 4 | 5 |
| First retardation | Rth (@550 nm) | −110 | −125 | −100 | −88 | −130 |
| layer | | | | | | |
| Second retardation | Re (@450 nm) | 99 | 99 | 117 | 139 | 113 |
| layer | Re (@550 nm) | 110 | 110 | 130 | 135 | 110 |
| | Re (@650 nm) | 116 | 116 | 137 | 134 | 108 |
| | Relation 1 | 0.9 | 0.9 | 0.9 | 1.03 | 1.03 |
| | Relation 2 | 1.05 | 1.05 | 1.05 | 0.99 | 0.98 |
| Laminate of first | Rth (@550 nm) | −30 | −37 | −30 | −23 | −62.5 |
| retardation layer and | Re (@550 nm) | 110 | 110 | 130 | 135 | 110 |
| second retardation | NZ (@550 nm) | 0.23 | 0.16 | 0.27 | 0.32 | −0.05 |
| layer | | | | | | |
| Contrast ratio | (20°, 50°) | 400 | 380 | 390 | 360 | 355 |

TABLE 2

| | | Comparative Example | | | | |
|---|---|---|---|---|---|---|
| | | 1 | 2 | 3 | 4 | 5 |
| First retardation | Rth (@550 nm) | −170 | −50 | −110 | −75 | −110 |
| layer | | | | | | |
| Second retardation | Re (@450 nm) | 99 | 99 | 41.5 | 149 | 143 |
| layer | Re (@550 nm) | 110 | 110 | 50 | 145 | 130 |
| | Re (@650 nm) | 116 | 116 | 54 | 144 | 124 |
| | Relation 1 | 0.9 | 0.9 | 0.83 | 1.03 | 1.1 |
| | Relation 2 | 1.05 | 1.05 | 1.08 | 0.99 | 0.95 |
| Laminate of first | Rth (@550 nm) | −80 | 5 | −95 | 5 | −10 |
| retardation layer and | Re (@550 nm) | 110 | 110 | 50 | 145 | 130 |
| second retardation | | | | | | |
| layer | | | | | | |
| Contrast ratio | (20°, 50°) | 150 | 150 | 10 | 20 | 200 |

As shown in Table 1, the polarizing plate according to the present invention can maximize a right-left opposite angle compensation function while improving a side contrast ratio at right and left opposite angles. In particular, the polarizing plate according to the present invention secured a contrast ratio of 350 at sides (20°, 50°) in the spherical coordinate system.

On the contrary, the polarizing plates of Comparative Examples 1 to 5 failing to satisfy requirements for the present invention could not provide the effects of the present invention and had much lower contrast ratios than 350 at sides (20°, 50°) in the spherical coordinate system.

It should be understood that various modifications, changes, alterations, and equivalent embodiments can be made by those skilled in the art without departing from the spirit and scope of the present invention.

1. A polarizing plate comprising a polarizer and first and second retardation layers formed on one surface of the polarizer, wherein:
the first retardation layer has an out-of-plane retardation Rth of about −130 nm to about −75 nm at a wavelength of about 550 nm;
the second retardation layer satisfies Relations 1 and 2;
a laminate of the first retardation layer and the second retardation layer has an out-of-plane retardation Rth of about −70 nm to about 0 nm at a wavelength of about 550 nm; and
the first retardation layer comprises a coating layer formed of a composition comprising a cellulose ester compound:
about 0.8≤Re(450)/Re(550)≤about 1.05 [Relation 1]
about 0.95≤Re(650)/Re(550)≤about 1.10 [Relation 2]
where Re(450), Re(550), and Re(650) denote in-plane retardations Re (unit: nm) of the second retardation layer at wavelengths of 450 nm, 550 nm, and 650 nm, respectively.

2. The polarizing plate according to claim 1, wherein the first retardation layer and the second retardation layer are sequentially stacked in the stated sequence from the polarizer.

3. The polarizing plate according to claim 1, wherein, assuming that an absorption axis of the polarizer is about 0°, an angle between a slow axis of the second retardation layer and the absorption angle of the polarizer ranges from about −5° to about +5°.

4. The polarizing plate according to claim 1, wherein the second retardation layer has an in-plane retardation Re of about 100 nm to about 150 nm at a wavelength of about 550 nm.

5. The polarizing plate according to claim 1, wherein the second retardation layer has an out-of-plane retardation Rth of about 40 nm to about 120 nm at a wavelength of about 550 nm.

6. The polarizing plate according to claim 1, wherein the second retardation layer is an MD uniaxially stretched film.

7. The polarizing plate according to claim 1, wherein the second retardation layer comprises a fluorene retardation layer.

8. The polarizing plate according to claim 7, wherein the fluorene retardation layer comprises a compound represented by Formula 1: 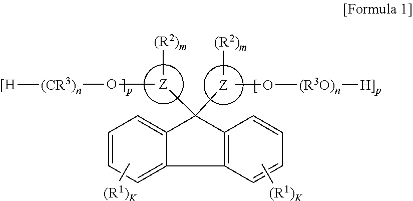
where Z is an aromatic hydrocarbon group; R¹ and R² are each independently a substituent group; R³ is a C₁ to C₁₀ alkylene group; n is an integer of 0 or more; k is an integer of 0 to 4; m is an integer of 0 or more, and p is an integer of 1 or more.

9. The polarizing plate according to claim 1, wherein the first retardation layer has an in-plane retardation Re of about 10 nm or less at a wavelength of about 550 nm.

10. The polarizing plate according to claim 1, wherein the first retardation layer is formed of a composition for the first retardation layer comprising the cellulose ester compound and an aromatic fused ring-containing additive.

11. The polarizing plate according to claim 10, wherein the aromatic fused ring-containing additive is present in an amount of about 0.1 wt % to about 30 wt % in the first retardation layer.

12. The polarizing plate according to claim 1, wherein the cellulose ester compound comprises at least one selected from among cellulose acetate, cellulose acetate propionate, and cellulose acetate butyrate.

13. The polarizing plate according to claim 10, wherein the aromatic fused ring-containing additive comprises at least one selected from among naphthalene, anthracene, phenanthrene, pyrene, Structure 1, Structure 2, 2-naphthyl benzoate, 2,6-naphthalene dicarboxylic acid diester of Structure 3, and an abietic acid ester of Structure 4: 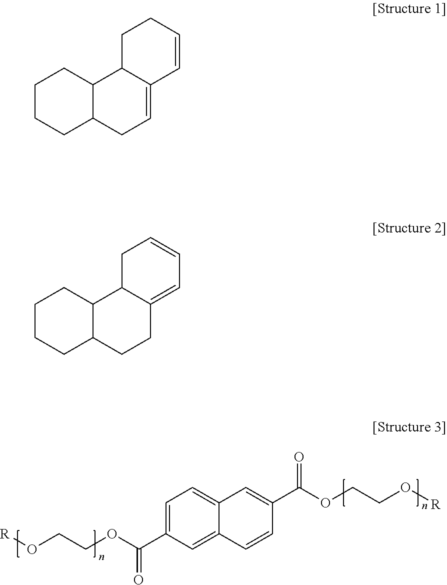
where R is a C₁ to C₂₀ alkyl or a C₆ to C₂₀ aryl, and n is an integer of 0 to 6 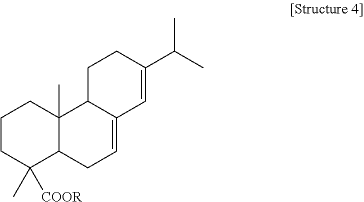
where R is a C₁ to C₂₀ alkyl or a C₆ to C₂₀ aryl.

14. The polarizing plate according to claim 1, wherein the first retardation layer is directly formed on the second retardation layer.

15. The polarizing plate according to claim 1, wherein the first retardation layer has a thickness of about 2 μm to about 10 μm.

16. The polarizing plate according to claim 1, wherein the laminate satisfies Relations 6 and 7:
about 0.9≤Rth(450)/Rth(550)≤about 1.3 [Relation 6]
about 0.8≤Rth(650)/Rth(550)≤about 1.1 [Relation 7]
where Rth(450), Rth(550), and Rth(650) denote out-of-plane retardations Rth (unit: nm) of the laminate at wavelengths of 450 nm, 550 nm, and 650 nm, respectively.

17. The polarizing plate according to claim 1, wherein the laminate has an in-plane retardation Re of about 100 nm to about 150 nm at a wavelength of about 550 nm.

18. The polarizing plate according to claim 1, wherein the laminate has a degree of biaxiality (NZ) of about −0.1 to about 0.5 at a wavelength of about 550 nm.

19. The polarizing plate according to claim 1, further comprising: a protective film on the other surface of the polarizer.

20. A liquid crystal display device comprising the polarizing plate according to claim 1.
